(19) United States
(12) Patent Application Publication
(10) Pub. No.: US 2011/0227859 A1
(43) Pub. Date: Sep. 22, 2011

(54) CAPACITIVE TOUCH PANEL

(75) Inventor: JANE HSU, TAOYUAN COUNTY (TW)

(73) Assignee: MINLEAD LTD., TAIPEI CITY (TW)

(21) Appl. No.: 12/786,909

(22) Filed: May 25, 2010

(30) Foreign Application Priority Data
Mar. 22, 2010 (TW) 099204986

(51) Int. Cl. G06F 3/045

(52) U.S. Cl. 345/174

(57) ABSTRACT

A capacitive touch panel has two basal plates, an adhesive ring and a dot spacer. Each of the two basal plates has a working surface and an outer rim. One basal plate further has a conductive area, a peripheral area and a metal wiring area. The peripheral area is defined between the outer rim and the conductive area. The adhesive ring is made with a reusable adhesive agent and clamped between the peripheral areas of the basal plates without contacting the conductive area. The dot spacer is clamped between the basal plates and positioned within the conductive area. The adhesive ring, being a reusable adhesive agent, does not stick fast to the conductive area and thus allows a manufacturer to accurately align the basal plates during manufacture and thus to raise yield rate.

### BACKGROUND OF THE INVENTION

1. Field of the Invention

The present invention relates to a capacitive touch panel, especially to a capacitive touch panel allowing fine adjustment of two basal plates in a manufacture process of the same and thus capable of preventing interference between the two basal plates.

2. Description of the Prior Art

Conventional touch panels are categorized into capacitive-type, resistance-type, sound-wave-type and optic-type due to their mechanisms. Capacitive touch panels are most popular among the aforementioned four kinds of conventional touch panels for overcoming the shortcoming of resistance-type touch panel that requires pressing of a user to operate, which generate unwanted scratches easily. Capacitive touch panels, on the contrary, are operated more with touching than pressing.

Capacitive touch panels are further categorized into superficial capacitive touch panels and projective capacitive touch panels, wherein the former is operated with single-point touching while the latter allows multiple-point touching.

A capacitive touch panel may comprise one basal panel or two basal panels. For example, Taiwan utility model application No. 98223215, filed on Dec. 11, 2009 discloses a projective capacitive touch panel comprising two basal panels.

A conventional capacitive touch panel comprising two basal panels comprises two basal plates and an optic adhesive agent. At least one basal plate comprises an indium tin oxide (ITO) conductive area and a metal wiring area. The ITO conductive area comprises crossing-over patterns of ITO. The crossing-over patterns are formed on a surface of the conductive area. For example, as shown in Taiwan utility model No. M379118, the crossing patterns of ITO may be multiple diamond-shaped conductive pads. Spaces are formed between the conductive pads. The conductive pads of one basal plate correspond to the spaces of the other basal plate in order to prevent interference due to overlapping conductive pads.

The metal wiring area is for connection of the ITO conductive area and a flexible circuit board. The optic adhesive agent is applied on a surface of at least one basal plate. The optic adhesive agent combines the two basal plates after being heated and thus a conventional capacitive touch panel is obtained.

Accurate alignment of the two basal plates, which is usually achieved with multiple aligning steps, is indispensable for a qualified capacitive touch panel free from interference due to overlapping of the crossing-over patterns of the two basal plates. However, current human-handed or mechanical means hardly align the two basal plates in a single-step operation. Once the optic adhesive, even before heating, is applied to the basal plates, removing the optic adhesive destroys the ITO conductive area or generates bubbles within the optic adhesive. Multiple aligning steps often disrupt or destroy the ITO conductive area, as well as generate bubbles that may interfere with electrical signals for capacitive computing. The multiple aligning steps, which are usually unavoidable during manufacture of a conventional capacitive touch panel, significantly lower yield rate of conventional capacitive touch panels.

To overcome the shortcomings, the present invention provides a capacitive touch panel to mitigate or obviate the aforementioned problems.

### SUMMARY OF THE INVENTION

The main objective of the invention is to provide a capacitive touch panel allowing fine adjustment of two basal plates in a manufacture process of the same and thus capable of preventing interference between the two basal plates.

The capacitive touch panel in accordance with the present invention has two basal plates, an adhesive ring and a dot spacer.

Each of the two basal plates has a working surface and an outer rim. One basal plate further has a conductive area, a peripheral area and a metal wiring area. The peripheral area is defined between the outer rim and the conductive area.

The adhesive ring is made with a reusable adhesive agent and clamped between the basal plates within the peripheral areas and without contacting the conductive area.

The dot spacer is clamped between the basal plates and positioned within the conductive area.

The adhesive ring, being a reusable adhesive agent, does not stick fast to the conductive area and thus allows a manufacturer to accurately align the basal plates during manufacture and thus to raise yield rate.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a capacitive touch panel in accordance with the present invention;

FIG. 2 is an exploded perspective view of a second embodiment of a capacitive touch panel in accordance with the present invention;

FIG. 3 is a top view of the capacitive touch panel in FIG. 2;

FIG. 4 is a sectional side view of the capacitive touch panel in FIG. 2;

FIG. 5 is an exploded perspective view of a third embodiment of a capacitive touch panel in accordance with the present invention; and

FIG. 6 is a top view of the capacitive touch panel in FIG. 5.

### DETAILED DESCRIPTION OF THE PREFERRED EMBODIMENTS

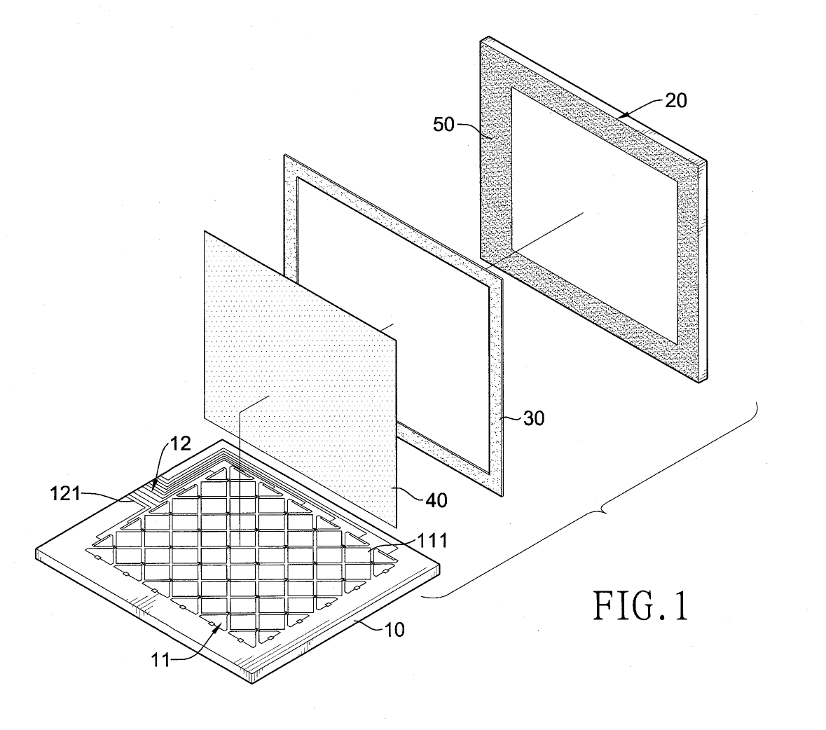

With reference to FIG. 1, a first embodiment of a capacitive touch panel in accordance with the present invention comprises two basal plates 10, 20, an adhesive ring 30, a dot spacer 40 and an insulated ink layer 50.

Each of the two basal plates 10, 20 comprises a working surface and an outer rim. One basal plate 10 further comprises a conductive area 11, a peripheral area and a metal wiring area 12. The conductive area 11 is defined on the working surface of the basal plate 10 and comprises multiple conductive pads 111. The conductive pads 111 are made of ITO. The peripheral area is defined between the outer rim and the conductive area 11. The metal wiring area 12 is defined on the working surface of the basal plate 10 and connects to the conductive area 11. The metal wiring area 12 comprises multiple silver wires 121.

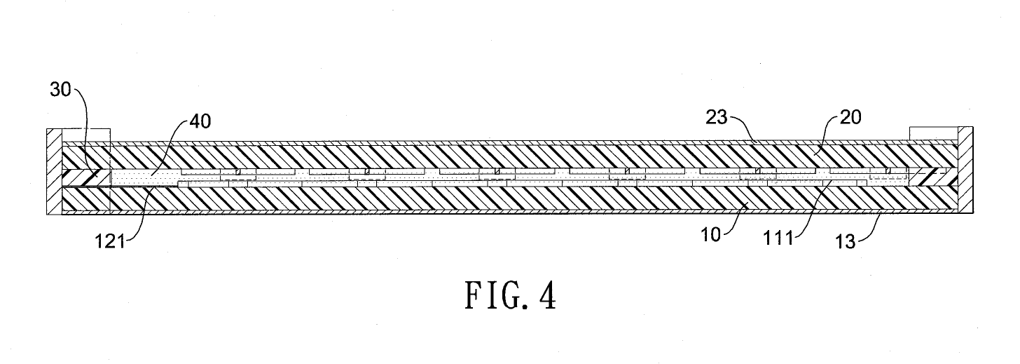

The insulated ink layer 50 is attached to the peripheral area of the other basal plate 20 for insulating the metal wiring area 12 from external interference. With reference to FIG. 4, the first embodiment of the capacitive touch panel comprises an electromagnetic shielding layer 13 and a silicon dioxide protection layer 23. The electromagnetic shielding layer 13 is attached to a bottom surface of one basal plate 10 that constitute a bottom portion of the capacitive touch panel. The silicon dioxide protection layer 23 is attached to a top surface of the other basal plate 20 positioned upon the foregoing basal plate 10 and constituting an upper portion of the capacitive touch panel.

The adhesive ring 30 may be made with a reusable adhesive agent is selected from the group consist of hydrogel, uv-curing glue, backing adhesive and pressure-sensitive adhesive. The adhesive ring 30 is clamped between the basal plates 10, 20 within the peripheral areas and without contacting the conductive area 11.

The dot spacer 40 is clamped between the basal plates 10, 20 and positioned within the conductive area 11.

A method for making the first embodiment of the capacitive touch panel comprises the following steps.

a) The first step is preparing two basal plates 10, 20. Each of the basal plates 10, 20 comprises a working surface and an outer rim. One basal plate 10 further comprises a conductive area 11, a peripheral area and a metal wiring area 12. The conductive area 11 is defined on the working surface of the basal plate 10. The peripheral area is defined between the outer rim and the conductive area 11. The metal wiring area 12 is defined on the working surface of the basal plate 10 and connected to the conductive area 11. The conductive area 11 comprises multiple conductive pads 111. The metal wiring area 12 comprises multiple silver wires 121. An insulated ink layer 50 is attached to the peripheral area of the other basal plate 20.

b) The second step is applying a reusable adhesive to the peripheral area of at least one basal plate 10 without contacting the conductive area 11. The reusable adhesive may be a hydrogel, a uv-curing glue, a backing adhesive or a pressure-sensitive adhesive. A dot spacer 40 is attached to the conductive area 11 of the basal plate 10.

c) The third step is to combining the basal plates 10, 20 with their working surfaces facing each other.

d) The forth step is aligning the basal plates 10, 20. In the current embodiment, a perpendicular aligning device is employed to engage the basal plates 10, 20. A pressure is applied to the outer rims of the basal plates 10, 20 to force accurate alignment of the same.

e) The fifth step is hot-pressing the combined basal plates 10, 20 to harden the reusable adhesive and obtain an adhesive ring 30 as hardened reusable adhesive.

A capacitive touch penal of the first embodiment is obtained with the foregoing steps.

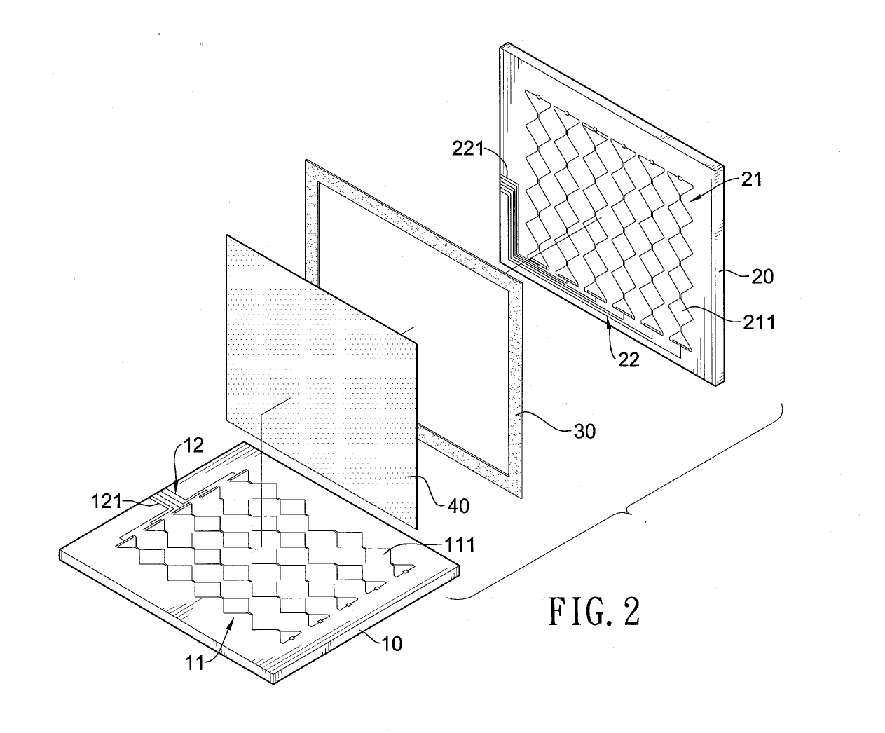

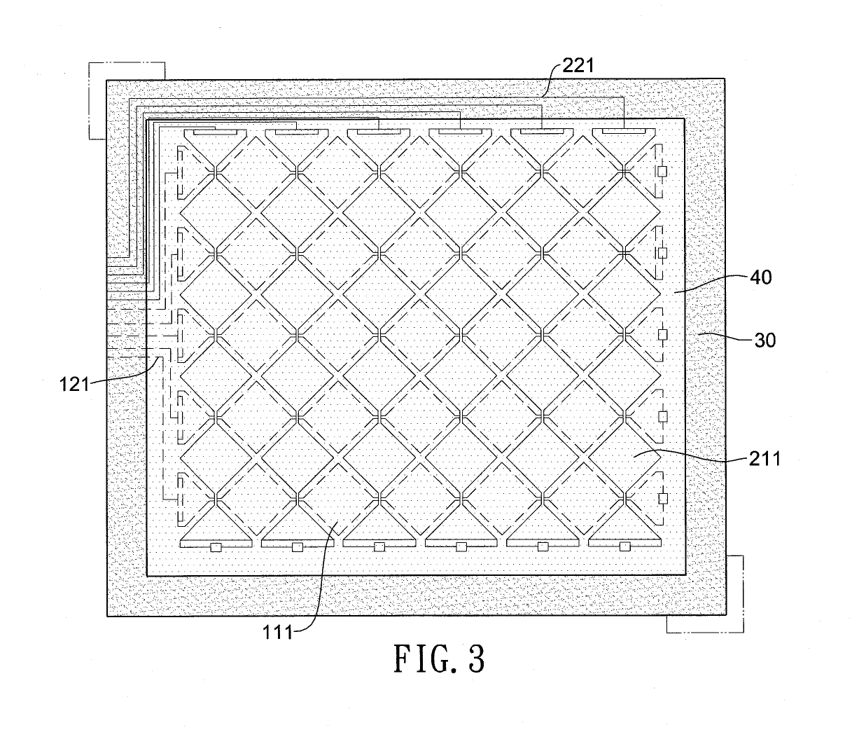

With reference to FIGS. 2 to 4, a second embodiment of a capacitive touch panel comprises two basal plates 10, 20, an adhesive ring 30 and a dot spacer 40.

Each of the two basal plates 10, 20 comprises a working surface, an outer rim, a conductive area 11, 21, a peripheral area and a metal wiring area 12, 22. Each conductive area 11, 21 is defined on the working surface of the basal plate 10, 20 and comprises multiple conductive pads 111, 211. The conductive pads 111, 211 are made of ITO. The shapes and conformation of the conductive pads 111, 211 are sophisticatedly designed so that the spaces between the conductive pads 111 of one basal plate 10 correspond to the conductive pads 211 of the other basal plate 20.

The peripheral area of each basal plate 10, 20 is defined between the outer rim and the conductive area 11, 21 of the same basal plate 11, 21. The metal wiring area 12, 22 of each basal plate 10, 20 is defined on the working surface of the same basal plate 10, 20 and connects to the conductive area 11, 21. Each metal wiring area 12, 22 comprises multiple silver wires 121, 221.

With reference to FIG. 4, the first embodiment of the capacitive touch panel comprises an electromagnetic shielding layer 13 and a silicon dioxide protection layer 23. The electromagnetic shielding layer 13 is attached to a bottom surface of one basal plate 10 that constitutes a bottom portion of the capacitive touch panel. The silicon dioxide protection layer 23 is attached to a top surface of the other basal plate 20 positioned upon the foregoing basal plate 10 and constituting an upper portion of the capacitive touch panel.

The adhesive ring 30 may be made with a reusable adhesive agent is selected from the group consisting of hydrogel, uv-curing glue, backing adhesive and pressure-sensitive adhesive. The adhesive ring 30 is clamped between the peripheral areas of the basal plates 10, 20 without contacting the conductive areas 11, 21.

The dot spacer 40 is clamped between the basal plates 10, 20 and positioned within the conductive areas 11, 21. The dot spacer 40 divides the conductive areas 11, 21 of the two basal plates 10, 20 and insulates the two basal plates 10, 20.

A method for making the second embodiment of the capacitive touch panel comprises the following steps.

a) The first step is preparing two basal plates 10, 20. Each of the two basal plates 10, 20 comprises a working surface, an outer rim, a conductive area 11, 21, a peripheral area and a metal wiring area 12, 22. Each conductive area 11, 21 is defined on the working surface of the basal plate 10, 20 and comprises multiple conductive pads 111, 211. The conductive pads 111, 211 are made of ITO. The peripheral area of each basal plate 10, 20 is defined between the outer rim and the conductive area 11, 21 of the same basal plate 11, 21. The metal wiring area 12, 22 of each basal plate 10, 20 is defined on the working surface of the same basal plate 10, 20 and connects to the conductive area 11, 21. Each metal wiring area 12, 22 comprises multiple silver wires 121, 221.

b) The second step is applying a reusable adhesive to the peripheral area of at least one basal plate 10, 20 without contacting the conductive area 11, 21. The reusable adhesive may be a hydrogel, a uv-curing glue, a backing adhesive or a pressure-sensitive adhesive.

c) The third step is clamping a dot spacer 40 between the conductive areas 11, 21 of the basal plates 10, 20.

d) The forth step is combining the basal plates 10, 20 with their working surfaces facing each other.

e) The fifth step is aligning the basal plates 10, 20. In the current embodiment, a perpendicular aligning device is employed. The basal plates 10, 20 are engaged in the perpendicular aligning device. Each of the basal plates 10, 20 has a rim. A pressure is applied to rims of the basal plates 10, 20 to force alignment of the same.

f) The sixth step is hot-pressing the combined basal plates 10, 20 to harden the reusable adhesive and obtain an adhesive ring 30 as hardened reusable adhesive.

A capacitive touch penal of the second embodiment is obtained with the foregoing steps.

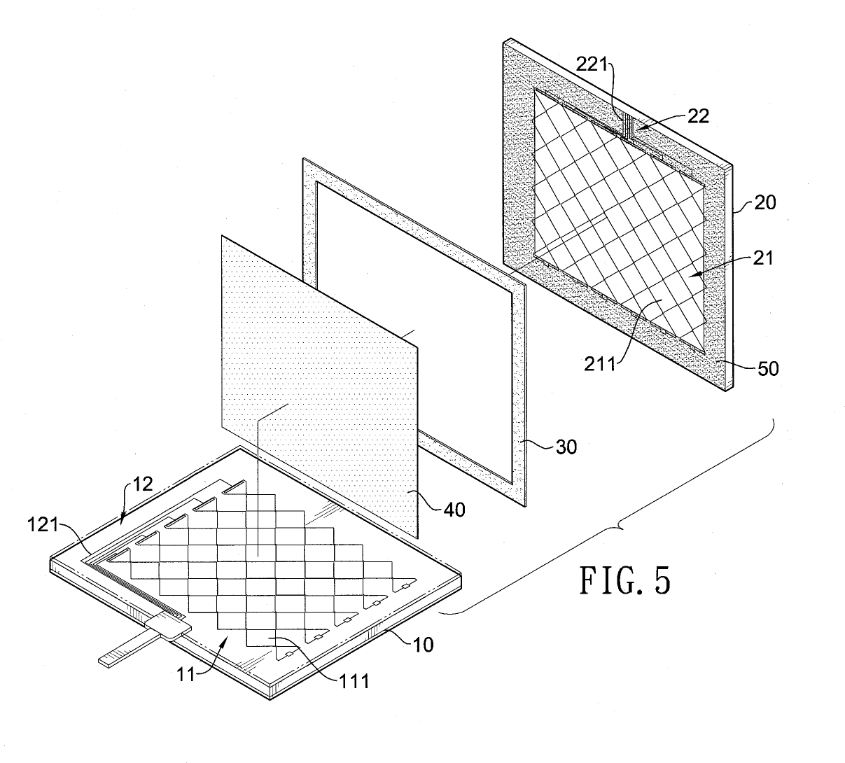

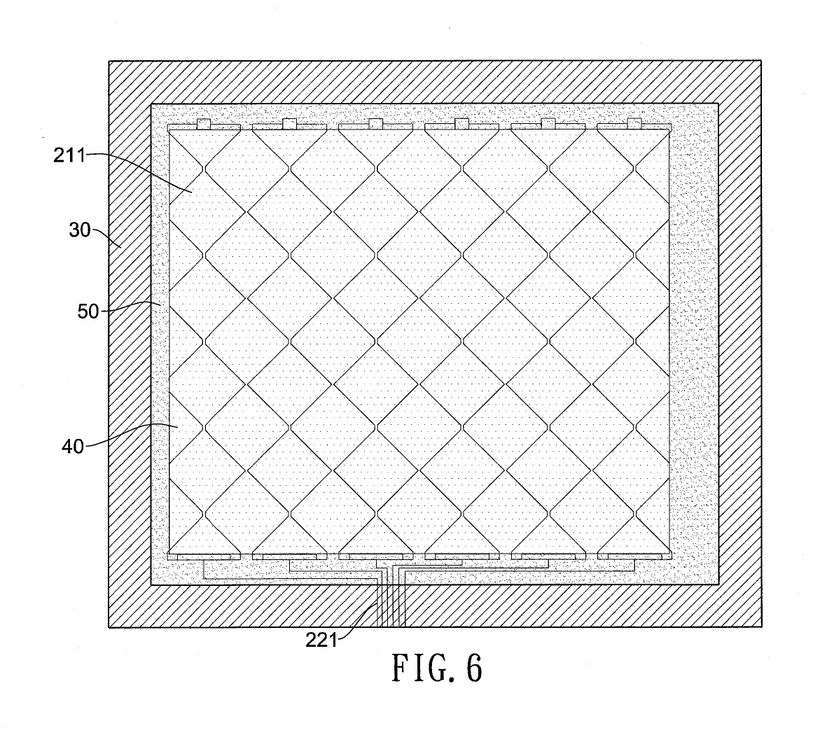

With reference to FIGS. 5 and 6, a third embodiment of a capacitive touch panel comprises two basal plates 10, 20, an adhesive ring 30, a dot spacer 40 and an insulated ink layer 50.

Each of the two basal plates 10, 20 comprises a working surface, an outer rim, a conductive area 11, 21, a peripheral area and a metal wiring area 12, 22. Each conductive area 11, 21 is defined on the working surface of the basal plate 10, 20 and comprises multiple conductive pads 111, 211. The conductive pads 111, 211 are made of ITO. The peripheral area of each basal plate 10, 20 is defined between the outer rim and the conductive area 11, 21 of the same basal plate 11, 21. The metal wiring area 12, 22 of each basal plate 10, 20 is defined on the working surface of the same basal plate 10, 20 and connects to the conductive area 11, 21. Each metal wiring area 12, 22 comprises multiple silver wires 121, 221.

With reference to FIG. 4, the first embodiment of the capacitive touch panel comprises an electromagnetic shielding layer 13 and a silicon dioxide protection layer 23. The electromagnetic shielding layer 13 is attached to a bottom surface of one basal plate 10 that constitute a bottom portion of the capacitive touch panel. The silicon dioxide protection layer 23 is attached to a top surface of the other basal plate 20 positioned upon the foregoing basal plate 10 and constituting a upper portion of the capacitive touch panel.

The adhesive ring 30 may be made with a reusable adhesive agent is selected from the group consist of hydrogel, uv-curing glue, backing adhesive and pressure-sensitive adhesive. The adhesive ring 30 is clamped between the peripheral areas of the basal plates 10, 20 without contacting the conductive areas 11, 21.

The dot spacer 40 is clamped between the basal plates 10, 20 and positioned within the conductive areas 11, 21. The dot spacer 40 divides the conductive areas 11, 21 of the two basal plates 10, 20 and insulates the two basal plates 10, 20.

The insulated ink layer 50 is attached to the peripheral area of one basal plate 20, wherein the basal plate 20 is preferred to be one that constitutes a upper portion of the capacitive touch panel. The conductive area 21 of the basal plate 20 comprises a rim. The insulated ink layer 50 contacts the rim of the conductive area 21. The insulated ink layer 50 may instead be attached to the peripheral area of the other basal plate 10 that constitutes a bottom portion of the capacitive touch panel.

A method for making the third embodiment of the capacitive touch panel is similar to the aforementioned method for making the second embodiment, wherein the current method differs from the method for making the second embodiment by further comprising an additional step before combining the basal plates 10, 20. The additional step is applying the insulated ink layer 50 between the adhesive ring 30 and one basal plate 20. The insulated ink layer 50 is attached to the peripheral area of one basal plate 20 and contacts a rim of the conductive area 21 of the basal plate 20.

The scope of the present invention covers any capacitive touch panel comprising two basal plates 10, 20. With the aforementioned structure of the capacitive touch penal in accordance with the present invention, accurate alignment of the two basal plates 10, 20 may be easily achieved, which prevents interference of the conductive areas 11, 21 of the two basal plates 10, 20. The foregoing advantages of the present invention help raise the quality of capacitive touch penal products as well as yield rate of the same.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A capacitive touch panel comprising
two basal plates each comprising
a working surface; and
an outer rim,
wherein at least one basal plate further comprises
a conductive area defined on the working surface of the basal plate;
a peripheral area defined between the conductive area and the outer rim; and
a metal wiring area defined on the working surface of the basal plate and connected to the conductive area;
an adhesive ring made with a reusable adhesive agent, clamped between the basal plates within the peripheral areas and without contacting the conductive area; and
a dot spacer clamped between the basal plates and positioned within the conductive area.

2. The capacitive touch panel as claimed in claim 1, wherein
the reusable adhesive agent is selected from the group consist of hydrogel, uv-curing glue, backing adhesive and pressure-sensitive adhesive.

3. The capacitive touch panel as claimed in claim 1, wherein
each of the two basal plate further comprises
a conductive area defined on the working surface of the basal plate;
a peripheral area defined between the conductive area and the outer rim; and
a metal wiring area defined on the working surface of the basal plate and connected to the conductive area.

4. The capacitive touch panel as claimed in claim 2, wherein
each of the two basal plate further comprises
a conductive area defined on the working surface of the basal plate and corresponding to the other conductive area; and
a metal wiring area defined on the working surface of the basal plate, connected to the conductive area and corresponding to the other metal wiring area.

5. The capacitive touch panel as claimed in claim 1, wherein
the capacitive touch panel further comprises
an insulated ink layer formed between the adhesive ring and one basal plate.
